(19) United States
(12) Patent Application Publication
(10) Pub. No.: US 2022/0108381 A1
(43) Pub. Date: Apr. 7, 2022

(54) METHODS AND APPARATUS TO MEASURE ONLINE PURCHASING HISTORY

(71) Applicant: Nielsen Consumer LLC, New York, NY (US)

(72) Inventors: Leah Korganowski, Markham (CA); Sedwin Vadukut, Tampa, FL (US); Saahil Udyavar, Clearwater, FL (US)

(21) Appl. No.: 17/239,101

(22) Filed: Apr. 23, 2021

Related U.S. Application Data
(60) Provisional application No. 63/088,970, filed on Oct. 7, 2020.

(51) Int. Cl. G06Q 30/06; G06N 20/00; G06F 16/951; G06F 16/9535

(52) U.S. Cl. CPC G06Q 30/0641; G06F 16/9535; G06F 16/951; G06N 20/00

(57) ABSTRACT

Methods, apparatus, and systems are disclosed to measure online purchasing history. An example apparatus includes a query controller to: generate a first request to a first order history page of a first retailer based on obtaining authorization to access the first order history page, and generate a second request to a second order history page of a second retailer based on obtaining authorization to access the second order history page, the first and second retailers selected based on a list of retailers, and a scrape controller to: scrape the first order history page and the second order history page, identify order characteristics based on information scraped from the first order history page and the second order history page, the order characteristics indicative of an online purchasing behavior corresponding to the first retailer and the second retailer, and store order characteristics in memory to provide to a central facility.

### RELATED APPLICATION

This patent arises from a continuation of U.S. Provisional Patent Application Ser. No. 63/088,970, which was filed on Oct. 7, 2020. U.S. Provisional Patent Application Ser. No. 63/088,970 is hereby incorporated herein by reference in its entirety. Priority to U.S. Provisional Patent Application Ser. No. 63/088,970 is hereby claimed.

### FIELD OF THE DISCLOSURE

This disclosure relates generally to the technical field of online purchasing history analysis, and, more particularly, to methods and apparatus to measure online purchasing history.

### BACKGROUND

In recent years, users have the option of purchasing products from retailers both online and off of a shelf. The users can create a personal online shopping account for purchasing products online. The retailer saves information on the personal account corresponding to user activity (e.g., purchasing history, name, address, phone number, email, etc.) for the user to view and the retailer to utilize in the future.

### BRIEF DESCRIPTION OF THE DRAWINGS

FIG. 1 is a schematic illustration of an example order history collection system to collect order history information from a number of example devices.

FIGS. 2A and 2B are example graphical user interfaces corresponding to one or more online retailers associated the at least one of the number of example devices implementing an example collection controller of FIG. 1.

FIG. 3 is a table of example data scraped from the example graphical user interfaces of FIGS. 2A and 2B.

FIG. 4 is a flowchart representative of machine readable instructions which may be executed to implement an example initiation phase of the example collection controller of FIG. 1.

FIG. 5 is a flowchart representative of machine readable instructions which may be executed to implement an example collection phase of the example collection controller of FIG. 1.

FIG. 6 is a flowchart representative of machine readable instructions which may be executed to implement an example initiation phase of the example collection controller of FIG. 1.

FIG. 7 is a block diagram of an example processing platform structured to execute the instructions of FIGS. 4-6 to implement the example collection controller of FIG. 1.

FIG. 8 is a block diagram of an example software distribution platform to distribute software (e.g., software corresponding to the example computer readable instructions of FIGS. 4-6) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Manufactures, advertisers, and competing retailers desire to know what products are bought online and what products are bought in store (e.g., off of the shelf). In particular, it may be beneficial for manufacturers to know what types of products (e.g., what categories, brands, etc.) are purchased online versus off the shelf and where from.

Some measurement entities that monitor online purchasing patterns also monitor user information, such as demographics relating to who bought the products online, when they bought the products online, and maybe why they bought the products online. However, such measurement entities require a number of permissions (e.g., contracts, service level agreements, etc.) from the retailer and/or the user to obtain demographics and purchasing history. Such permissions can be hard to obtain and, thus, purchasing history (e.g., purchasing information) of users on some retailer sites may be unobtainable. Therefore, such measurement entities are limited to monitoring the retailers that grant access to purchasing information.

Examples disclosed herein obtain user order history from a variety of online retailers to determine what products the users are buying online. Examples disclosed herein track user order history at a broad and widespread scale rather than at an individual scale. For example, some examples disclosed herein do not obtain information about the user purchasing the product online, but instead obtain information about what product was bought, what promotions were included with the product, from what retailer the product was purchased, etc.

Examples disclosed herein include a collection controller to obtain online purchasing history based on scraping, parsing, and identifying relevant information from order history datastores of online retailers. For example, some online retailers have static order history pages available when a user purchases a product. As such, the collection controller can efficiently extract information from the static order history pages based on identifying how information is set up and/or displayed in the static order history pages. In some examples, the collection controller scrapes data from an online listing of purchases made in stores and purchases made online. For example, some online retailers display a listing of products the user bought in store and a listing of products bought online based on utilizing the user's credit card information to link store purchases to the user's online account. In such examples, the collection controller scrapes data from the listing of products bought online.

In some examples, the collection controller may periodically (or aperiodically) retrieve these pages, scrape (e.g., copy, gather, obtain, and/or collect data) the information from the order history pages, and provide the information to a central facility for further processing. Examples disclosed herein scrape the order history pages from a plurality of users and a plurality of retailers from which the plurality of users make purchases. For example, if a user has a user account with four online retailers (e.g., samplewebsite1.com, samplewebsite2.com, samplewebsite3.com, and samplewebsite4.com), examples disclosed herein retrieve the user's order history pages of the four retailers (e.g., www.samplewebsite1.com/order-history) to obtain purchasing information. In some examples, thousands to hundreds of thousands of users having user accounts with at least two or more retailers can accumulate an amount of information (e.g., online purchasing data) that is too much to be manual processed by a human and, thus, is at a greater risk of being inaccurate due to human error. Therefore, examples disclosed herein improve the accuracy of identifying and processing online purchasing history data by eliminating the need for manual processing by a human and, thus, reducing inaccurate data due to human error.

Examples disclosed herein (e.g., the collection controller) are implemented by an Internet extension, such as an extension for a web browser (e.g., an extension for a personal computer web browser, an extension for a mobile device web browser, etc.). The extension may be downloaded and installed on a device that the user uses to purchase products from the online retailers or on any other device on which the user has authenticated with online retailers (e.g., logged into, signed into, stored credentials, etc.). The extension (e.g., the collection controller), once downloaded, targets the online retailers for which the user has an account and obtains purchase information from the order history by scraping the order history. To target the online retailers and obtain information from the order history pages, the user must be logged into their user account on each retailer site. In some examples, the extension may collect purchase history without accessing, scraping, and/or identifying user information such as passwords, personal information, etc.

Some examples disclosed herein operate passively, such that once a user is logged into their personal shopping accounts with select retailers (or once the usernames and passwords are saved, cookies are stored, etc.), the extension automatically checks order history datastores without the need for user intervention. Alternatively, checking maybe performed in response to a user action (e.g., a user may click a button, link, etc. to request checking of order history(ies), may specify a time period for which order history should be retrieved, etc.). In some examples, the extension may monitor websites visited by a browser and may retrieve the order history from a site in response to detecting a visit to an online retailer for which the extension includes information for accessing the order history page. In some examples, the extension can intelligently (e.g., utilizing machine learning, etc.) detect target retailer pages based on location of the device which the extension is installed. For example, some countries for the same retailer have different order collection approaches or some countries have different popular retailers than other countries that may be desirable to target (e.g., collect order history data from).

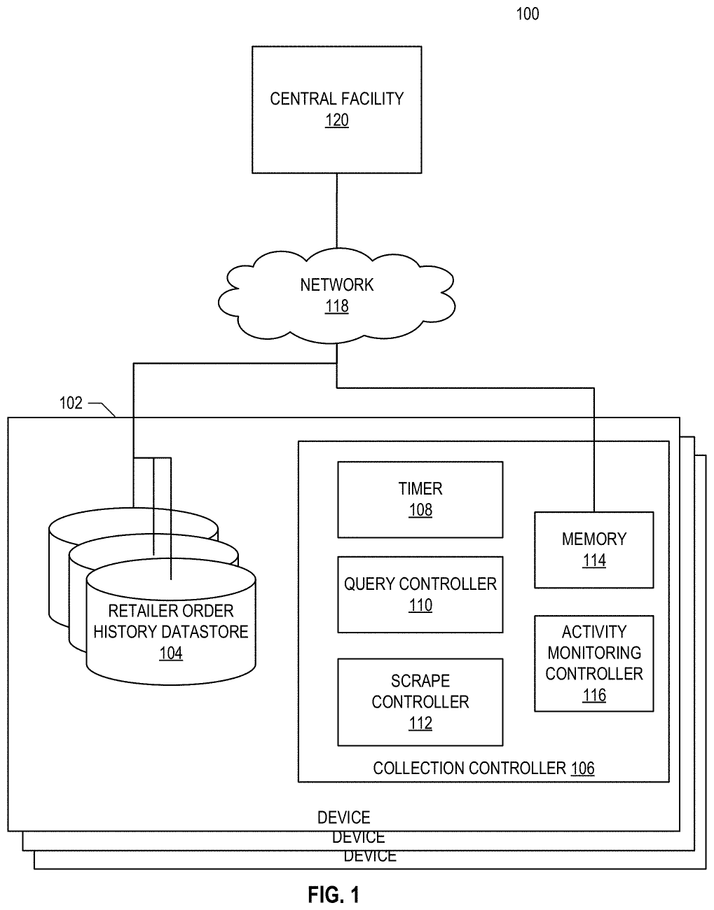

FIG. 1 is a schematic illustration of an example order history collection system 100 to collect order history information from a number of example devices 102. The example devices 102 include example retailer order history datastores 104 and an example collection controller 106. The example collection controller 106 includes an example timer 108, an example query controller 110, an example scrape controller 112, an example memory 114, and an example activity monitoring controller 116. The example order history collection system 100 includes an example network 118 and an example central facility 120.

In FIG. 1, the example device(s) 102 is/are implemented by computers, such as mobile phones, laptops, desktops, tablets, etc. The example device 102 may correspond to a particular user, such that the user uses the device 102 for online shopping. In some examples, the device 102 may correspond to multiple users, such as a family. In such an example, the multiple users may share the same accounts on the device 102 for online shopping and/or may have individual accounts on the device 102 for online shopping. In some examples, the user and/or users can use the device 102 for online shopping because the device 102 is coupled to the network 118 via Wi-Fi, Ethernet, and/or cellular data connection to obtain data for the online shopping. In FIG. 1, the example network 118 is the Internet.

In FIG. 1, the example device(s) 102 include the example retailer order history datastores 104 that are accessible by the example device(s) 102 via a connection to the example network 118 and/or implemented by the example device(s) 102 (e.g., displayed by the device(s) 102). The example retailer order history datastores 104 include and/or store data corresponding to order history of the user(s) of the example device(s) 102. In some examples, the retailer order history datastores 104 are used by a retailer application that has been personalized by the user (e.g., logged into by the user of the device 102). In examples disclosed herein, the data included in and/or stored by the retailer order history datastores 104 includes products purchased by the user, the location where the user purchased the products, the cost of the product, quantity of products, promotional deals on the product, and any other type of relevant information corresponding to the product, the user(s), the retailer, and/or the device(s) 102. The retailer order history datastore(s) 104 of this example may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The retailer order history datastore(s) 104 may additionally or alternatively be implemented by one or more double data rate (DDR) memories, such as DDR, DDR2, DDR3, DDR4, mobile DDR (mDDR), etc. The retailer order history datastore(s) 104 may additionally or alternatively be implemented by one or more mass storage devices such as hard disk drive(s), CD drive(s), DVD drive(s), solid-state disk drive(s), etc. While in the illustrated example the retailer order history datastore(s) 104 are illustrated as a number and/or type(s) of datastores, the retailer order history datastore(s) 104 may be implemented by a single datastore. Furthermore, the data stored in the retailer order history datastore(s) 104 may be in any data format such as, for example, binary data, comma delimited data, tab delimited data, SQL structures, etc.

In FIG. 1, the example collection controller 106 is implemented by an extension, such as an Internet extension (e.g., Google Chrome extension) and/or a mobile extension. In some examples, the collection controller 106 (e.g., extension) is installed by the user(s) of the device(s) 102. In other examples, the collection controller 106 is installed by the central facility 120. The example collection controller 106 requests permission to access the applications (e.g., retailer applications) upon installation of the collection controller 106. For example, the collection controller 106 may generate notifications requesting the user(s) to agree to give the collection controller 106 access to accounts with the retailer applications. In some examples, the collection controller 106 generates notifications that inform the user(s) to stay logged into their accounts and/or save their passwords to their accounts.

The example collection controller 106 obtains information from the retailer applications, such as the information included in the example retailer order history datastores 104. For example, retailer applications populate the retailer order history datastores 104 with information when user(s) purchase products online and the collection controller 106 obtains such information. The example collection controller 106 operates on an ongoing basis (e.g., obtains information from retailer order history datastores 104 on an ongoing basis, etc.) passively without the need for user intervention. For example, in response to passwords and usernames for respective personal retailer accounts are saved, the collection controller 106 obtains order history data on a regular scheduled basis.

In some examples, the collection controller 106 determines a location of the device(s) 102 to determine which target retailers to obtain order history information from. For example, the collection controller 106 can utilize the location services of the device(s) 102 to determine the location of the device(s). In other examples, the collection controller 106 detects the location of the device(s) based on the user's online shopping habits. For example, the collection controller 106 can monitor user activity (e.g., what online retailers have been visited, etc.) over a period of time and utilize trained machine learning model(s) to generate a probability that a user is in a certain location based on the user activity. Such machine learning model(s) can be trained based distances between retailer locations, known locations of retailers, etc. In some examples, location is utilized because different locations (e.g., countries, states, provinces, etc.) have different retailers. For example, retailers who have saturated a domestic market may globalize their business in an effort to access new customers and new capital. In other examples, retailers who have not saturated a domestic market, who are still growing domestically, who do not have means to expand, who do not desire to expand, etc., may have a static location. In such an example, the device(s) 102 located in that static location may have access to such a retailer, but the device(s) 102 not located in that static location may not have access to such a retailer. Therefore, the example collection controller 106 can identify target retailers based on location to avoid time spent searching and/or scanning for a particular retailer that does not market to the location.

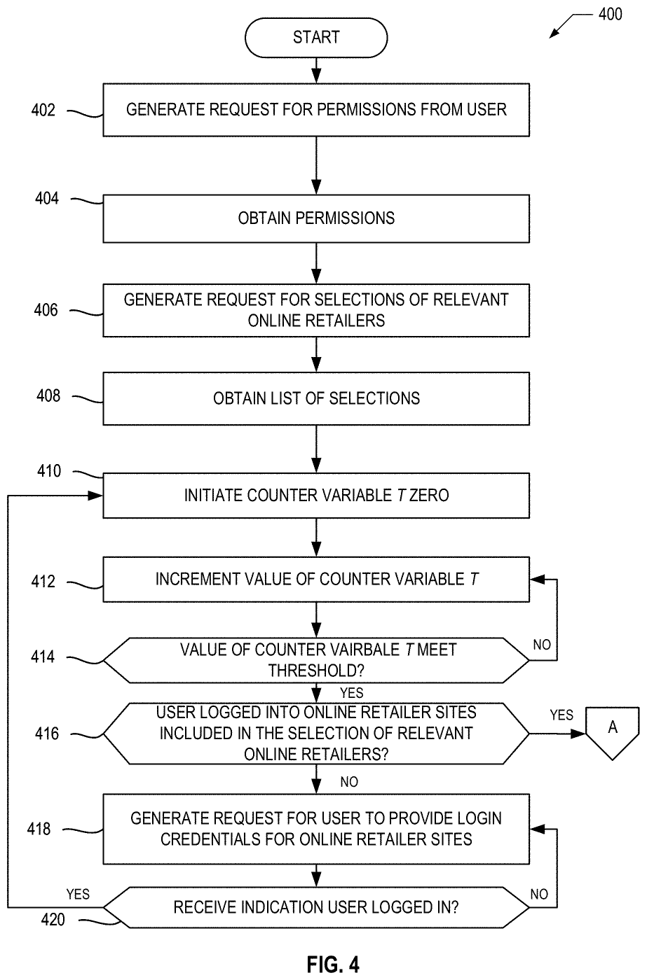

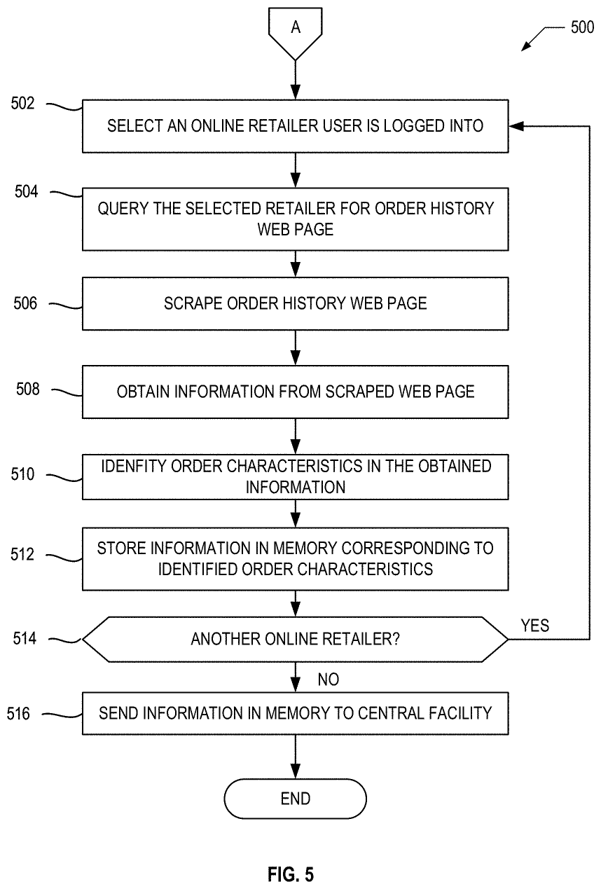

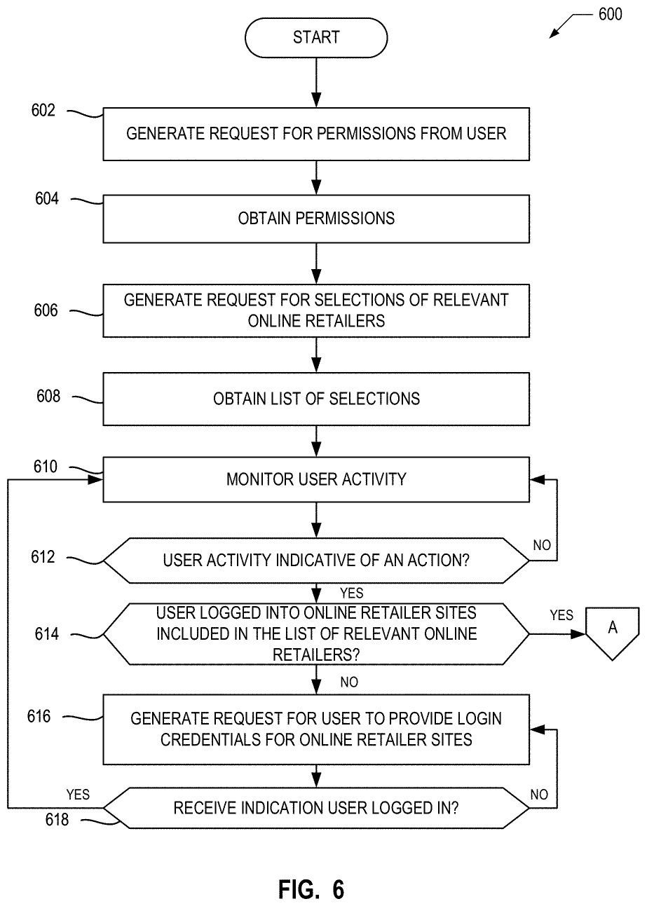

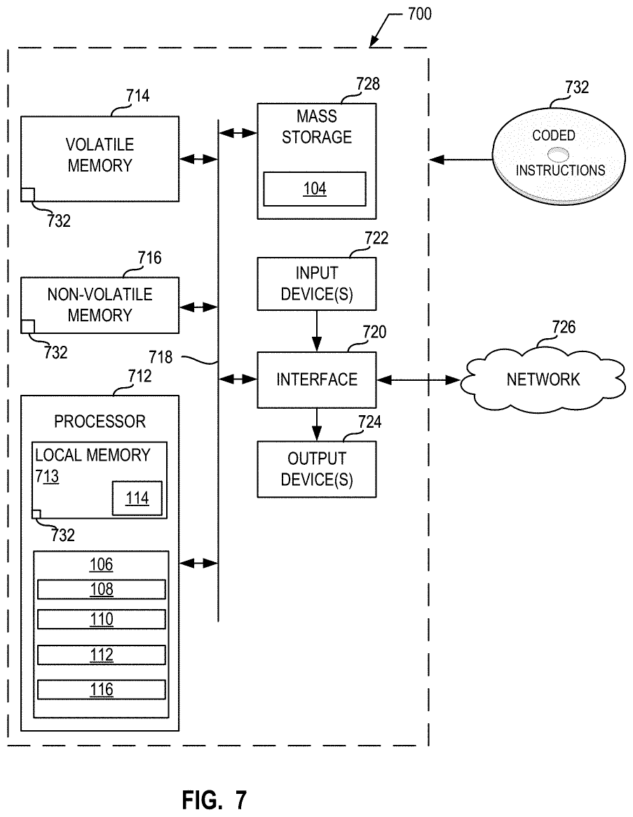

In some examples, the collection controller 106 implements means for collecting order history data, means for controlling the collection of order history data, and/or collecting means. The collecting means is implemented by executable instructions such as that implemented by at least blocks 402, 404, 406, 408, 410, 412, 414, 416, 418, and 420 of FIG. 4, blocks 502, 504, 506, 508, 510, 512, 514, and 516 of FIG. 5, and/or at least blocks 602, 604, 606, 608, 610, 612, 614, 616, and 618 of FIG. 6. The executable instructions of blocks 402, 404, 406, 408, 410, 412, 414, 416, 418, and 420 of FIG. 4, blocks 502, 504, 506, 508, 510, 512, 514, and 516 of FIG. 5, and/or at least blocks 602, 604, 606, 608, 610, 612, 614, 616, and 618 of FIG. 6 may be executed on at least one processor such as the example processor 712 of FIG. 7. In other examples, the collecting means is implemented by hardware logic, hardware implemented state machines, logic circuitry, and/or any other combination of hardware, software, and/or firmware.

In FIG. 1, the example collection controller 106 includes the example timer 108. In some examples, the timer 108 operates as a counter. The example timer 108 counts for a pre-defined period of time. The pre-defined period of time corresponds to the amount of time that the collection controller 106 is to collect and/or obtain information from the retailer order history datastores 104. In some examples, the timer 108 is initiated upon installation of the collection controller 106. For example, the timer 108 includes a count variable T, where Tis initialized to zero when the collection controller 106 is installed, activated, etc., at the device(s) 102. In some examples, the timer 108 triggers the query controller 110 when the count variable T equals the pre-defined period of time. In some examples, the central facility 120 defines and initializes the pre-defined period of time. The counter variable Tis indicative of a period of time between querying a retailer(s) for order history webpage(s). For example, counter variable Tis reset (e.g., initialized to zero) after each query generated by the query controller 110.

In some examples, the timer 108 implements means for counting and/or counting means. The counting means is implemented by executable instructions such as that implemented by at least blocks 410, 412, 414 of FIG. 4. The executable instructions of blocks 410, 412, 414 of FIG. 4 may be executed on at least one processor such as the example processor 712 of FIG. 7. In other examples, the counting means is implemented by hardware logic, hardware implemented state machines, logic circuitry, and/or any other combination of hardware, software, and/or firmware.

In FIG. 1, the example collection controller 106 includes the example query controller 110. The example query controller 110 is implemented by a controller. The example query controller 110 controls the query of information from the user(s) and the retailer order history datastores 104. For example, the query controller 110 controls requests to user(s) and controls requests to retailer applications for information from retailer order history datastores 104. In some examples, the query controller 110 generates a request for permissions from the user(s) to obtain authorization to access order history information. For example, the query controller 110 may ask the user for permission to access the retailer order history datastores 104 of their personal retailer user accounts. In some examples, such a request indicates that no demographic information (e.g., personal information) will be collected. In some examples, the query controller 110 generates query requests for users to select, from a pre-defined list, a number of online retailers with which the user(s) hold(s) accounts. For example, the central facility 120 may provide the collection controller 106 with a list of retailers from which the collection controller 106 is to obtain purchasing data. Therefore, the example query controller 110 uses this list to generate the request for the number of online retailers for which the user(s) hold(s) accounts. In some examples, the list of retailers are retailers who employ media monitoring companies (e.g., Nielsen Consumer, LLC) to provide purchasing behavior statistics, purchasing reports, etc., corresponding to their products.

In some examples, the query controller 110 generates requests corresponding to the retailer order history datastores 104. Such requests include, but are not limited to, uniform resource locator (URL) requests (e.g., a web address request) of static order history pages (e.g., webpages corresponding to retailer order history datastores 104). In some examples, the query controller 110 utilizes the URL request to obtain a webpage from respective online retailers (e.g., an online retailer whom the URL request is designated for). In some examples, the responses include webpages having purchasing data, images (e.g., web images) of the retailer order history datastores 104, etc. In some examples, the query controller 110 obtains one or more responses from the online retailers and/or the retailer order history datastores 104 when the user is logged in and/or when user(s) credentials are saved in a memory of the device(s) 102.

In some examples, the query controller 110 determines if the data in the response(s) is/are relevant for scraping. For example, the query controller 110 determines whether purchase history, included in the data, includes new information, such as new purchase information, not yet obtained by the collection controller 106. In some examples, the query controller 110 queries the memory 114 to determine whether data is relevant (e.g., whether the data includes new information). If such a condition is true (e.g., if the query controller 110 obtains a response including new and/or updated information), the example query controller 110 triggers the example scrape controller 112. In other examples, the scrape controller 112 determines if the data in the response(s) is/are relevant for scraping.

In some examples, the query controller 110 implements means for querying, means for controlling requests, means for controlling query requests, and/or querying means. The querying means is implemented by executable instructions such as that implemented by at least blocks 402, 404, 406, 408, 416, 418, and 420 of FIG. 4, blocks 502, 504, 514 of FIG. 5, and/or at least blocks 602, 604, 606, 608, 616, and 618 of FIG. 6. The executable instructions of blocks 402, 404, 406, 408, 416, 418, and 420 of FIG. 4, blocks 502, 504, 514 of FIG. 5, and/or at least blocks 602, 604, 606, 608, 616, and 618 of FIG. 6 may be executed on at least one processor such as the example processor 712 of FIG. 23. In other examples, the querying means is implemented by hardware logic, hardware implemented state machines, logic circuitry, and/or any other combination of hardware, software, and/or firmware.

In FIG. 1, the example scrape controller 112 is implemented by a controller, such as the example collection controller 106. The example scrape controller 112 scrapes information from the retailer order history datastores 104 responsive to a notification (e.g., a trigger) from the example query controller 110. In some examples, the scrape controller 112 obtains, views, and/or otherwise accesses a webpage, such as a Hypertext Markup Language (HTML) webpage, corresponding to one or more of the retailer order history datastores 104. In such an example, the scrape controller 112 extracts data (e.g., purchasing history, such as product bought, quantity, price, promotional information, etc.) in the form of lists and/or tables from the webpage (e.g., HTML webpage) utilizing machine learning (ML), scraping algorithms, and/or any other type of data extraction algorithm. In some examples, the scrape controller 112 utilizes an ML model to predict which data is most relevant on the webpage. In some examples, the central facility 120 trains such an ML model to identify and predict relevant purchasing data from webpages.

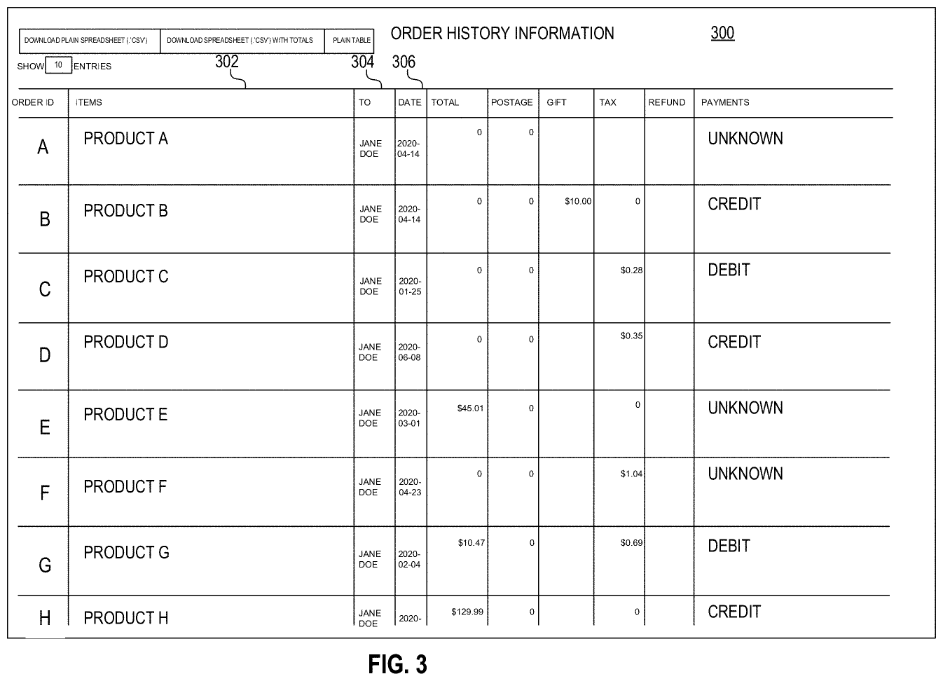

In some examples, the scrape controller 112 utilizes a combined data collection approach depending on the retailer. The combined data collection approach includes screen scraping order history URLs (e.g., HTML webpages such as retailer order history datastores 104) and extracting data if a data structured format (e.g., a clearly defined and searchable type of data format) is available, such as extensible markup language (XML), tabular data formats, etc. In other examples, the combined collection approach includes screen scraping order history URLs (e.g., HTML webpages) and extracting data via an application programming interface (API) if the API is available for a specific online retailer. The example scrape controller 112 may generate a list, report, etc., of the parsed information from the scrape and store the list, report, etc., in memory 114. An example of a list generated by the example scrape controller 112 is illustrated in FIG. 3 and described below.

In some examples, the scrape controller 112 implements means for scraping data, means for extracting data, means for generating a table of data, and/or scraping means. The scraping means is implemented by executable instructions such as that implemented by at least blocks 506, 508, 510, 512, and 514 of FIG. 5. The executable instructions of blocks 506, 508, 510, 512, and 514 of FIG. 5 may be executed on at least one processor such as the example processor 712 of FIG. 7. In other examples, the scraping means is implemented by hardware logic, hardware implemented state machines, logic circuitry, and/or any other combination of hardware, software, and/or firmware.

In FIG. 1, the example memory 114 may be implemented by a cache, a volatile memory, a non-volatile memory, and/or an external memory. In some examples, the memory 114 is implemented by a storage medium on the device 102. In some examples, the memory 114 is in communication with the network 118. For example, the memory 114 may provide stored data to the central facility 120 over and/or via the network 118.

In FIG. 1, the example activity monitoring controller 116 is implemented by a controller, such as the example collection controller 106. The example activity monitor controller 116 monitors user activity with the device 102. For example, the activity monitor controller 116 obtains notifications corresponding to a user interaction with a device 102. For example, the activity monitor controller 116 obtains notifications when a user clicks, touches, slides, and/or unlocks the device 102. In some examples, the activity monitor controller 116 obtains such notifications by periodically (or aperiodically) querying an event register (e.g., a hardware register that logs events of the device 102), a history file of the device 102, and/or any type of storage medium/hardware that keeps track of activity on the device 102. In some examples, the activity monitor controller 116 monitors user activity in order to initiate the query controller 110 and/or the scrape controller 112. For example, the activity monitor controller 116 notifies the query controller 110 to generate a query request for order history pages (e.g., retailer order history datastores 104) responsive to obtaining a notification corresponding to a click event (e.g., an action taken by the user to purchase a product online, open the online retailer application, etc.). In such an example, the query controller 110 can determine whether the order history pages include new information (e.g., information not previously scraped by the scrape controller 112) based on data stored in memory 114.

In some examples, the activity monitoring controller 116 implements means for monitoring user activity, means for obtaining user activity, and/or monitoring means. The monitoring means is implemented by executable instructions such as that implemented by at least blocks 610, 612, and 614 of FIG. 6. The executable instructions of blocks 610, 612, and 614 of FIG. 6 may be executed on at least one processor such as the example processor 712 of FIG. 7. In other examples, the monitoring means is implemented by hardware logic, hardware implemented state machines, logic circuitry, and/or any other combination of hardware, software, and/or firmware.

In FIG. 1, the central facility 120 is implemented by one or more servers. The example central facility 120 provides the collection controller 106 to the device 102. For example, the central facility 120 configures the collection controller 106 and provides the example device 102 with access to the collection controller 106. In some examples, during installation and/or registration of the collection controller 106 in the device 102, the central facility 120 receives (e.g., obtains) user permissions (e.g., permissions of the central facility 120 to access users' retailer order history datastores 104). During operation of the collection controller 106, the central facility 120 obtains order history information from the scrape controller 112. In some examples, the order history information corresponds to one or more of the retailer order history datastores 104. The central facility 120 processes and stores data received from the collection controller 106 and/or the scrape controller 112. For example, the example central facility 120 combines product information (e.g., product label, product price, product promotion, etc.) and retailer information (e.g., retailer name, location, etc.) to generate a list of products bought online. The central facility 120 generates reports for the retailer companies and/or other interested parties based on the compiled data.

While a single central facility 120 is shown in FIG. 1, a plurality of central facilities 120 may be implemented and/or included to configure collection controller(s) 106 and provide access to different devices 102 as well as to obtain order/purchasing history information from the collection controllers 106 of the different devices 102.

While an example manner of implementing the device 102 is illustrated in FIG. 1, one or more of the elements, processes and/or devices illustrated in FIG. 1 may be combined, divided, re-arranged, omitted, eliminated and/or implemented in any other way. Further, the example retailer order history datastores 104, the example collection controller 106, the example timer 108, the example query controller 110, the example scrape controller 112, the example memory 114, the activity monitoring controller 116, and/or, more generally, the example device 102 of FIG. 1 may be implemented by hardware, software, firmware and/or any combination of hardware, software and/or firmware. Thus, for example, any of the example retailer order history datastores 104, the example collection controller 106, the example timer 108, the example query controller 110, the example scrape controller 112, the example memory 114, the activity monitoring controller 116, and/or, more generally, the example device 102 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example retailer order history datastores 104, the example collection controller 106, the example timer 108, the example query controller 110, the example scrape controller 112, the example memory 114, and/or the activity monitoring controller 116 is/are hereby expressly defined to include a non-transitory computer readable storage device or storage disk such as a memory, a digital versatile disk (DVD), a compact disk (CD), a Blu-ray disk, etc. including the software and/or firmware. Further still, the example device 102 may include one or more elements, processes and/or devices in addition to, or instead of, those illustrated in FIG. 1, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

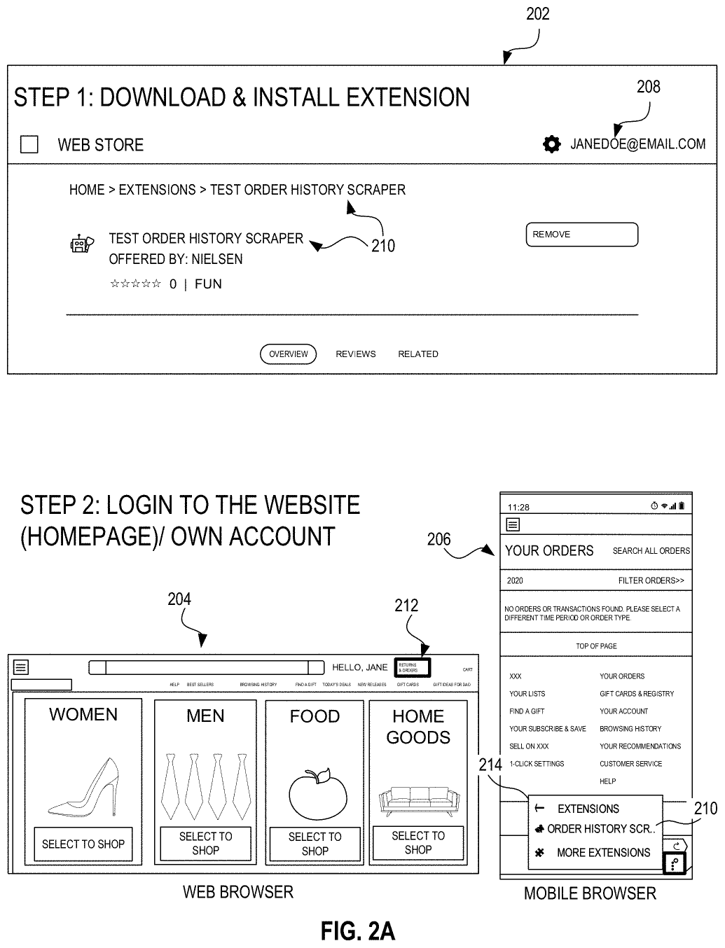

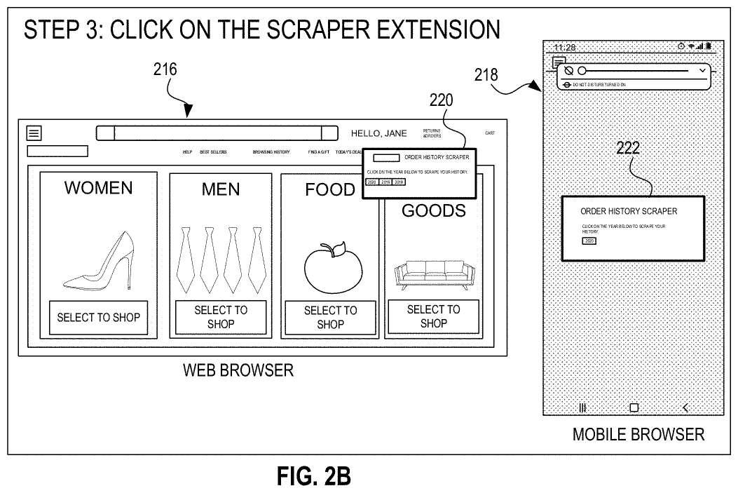

FIGS. 2A and 2B illustrate example graphical user interfaces of one or more of the retailers associated with the device 102. In FIG. 2A, an example first interface 202 illustrates a web store at which the example collection controller 106 is downloaded and installed by a computing device, such as a mobile device, a laptop, a tablet, etc., and corresponds to a first step of an operation of the collection controller 106. In FIG. 2A, an example second interface 204 is illustrated. The example second interface 204 is an online retailer interface of a web browser (e.g., a browser interface of a desktop computer, etc.) and corresponds to a second step of the operation of the collection controller 106. In FIG. 2A, an example third interface 206 is illustrated. The example third interface 206 is an online retailer interface of a mobile browser (e.g., a browser of a cell phone, etc.) and corresponds to the second step of the operation of the collection controller 106.

The example first interface 202 is associated with a user 208. For example, the first interface 202 is associated with the user 208 having an email address of “janedoe@email.com”. In the example of FIG. 2A, the user 208 having the email address of “janedoe@email.com” is the user 208 receiving requests (e.g., permission requests) from the example collection controller 106, the user 208 whom the order history corresponds to, and/or the user 208 who downloads and installs the collection controller 106. In the example first interface 202, the collection controller 106 is implemented by an extension 210 labelled “order page scraper.” In the example operation of the collection controller 106, once the first step is complete (e.g., downloading and installing the collection controller 106), the query controller 110 of FIG. 1 and/or more generally, the collection controller 106, may generate a request to the user 208 for access to retailer applications that the user 208 has installed on the example device 102. In some examples, the query controller 110 and/or more generally, the collection controller 106 generates a list of online retailers for the user 208 to select from, the selection of online retailers corresponding to retailers that the user 208 purchases from and holds accounts with.

In the example operation of the collection controller 106, the second step is initiated in response to the query controller 110 obtaining the selected list of online retailers from the user 208. The second step includes logging into online retailer accounts. For example, the query controller 110 and/or more generally, the collection controller 106, generates a request to the user 208 indicative to save online retailer account credentials (e.g., username and password) and/or to give permissions for the collection controller 106 to access the retailer accounts of the user 208.

When logged into the retailer account, the user 208 obtains the second interface 204 or the third interface 206, depending on what type of device the user 208 is utilizing. The example second interface 204 illustrates a homepage of a web browser retailer account that is personalized to the user 208. For example, the second interface 204 includes a welcome message with the name of the user 208 and includes and a retailer order history link 212 (e.g., the “Returns & Orders” link) that, when clicked, directs the user 208 to an example retailer order history interface.

The example third interface 206 illustrates a retailer order history page of a mobile browser retailer account that is personalized to the user 208. The third interface 206 may display information stored at one of the retailer order history datastores 104 of FIG. 1. For example, the third interface 206 includes a history of purchases the user 208 has made with the online retailer on a mobile device. The example third interface 206 includes an extension library 214, including the extension 210 corresponding to the collection controller 106. In some examples, the extension 210 runs in the background of the third interface 206, such that the extension 210 accesses the third interface 206 and/or information displayed by the third interface 206 each time a period of time passes, activity events occur, or any type of trigger occurs that causes the extension 210 to access the third interface 206. In examples where the user 208 is utilizing a different device (e.g., a device presenting and/or displaying the second interface 204), the extension 210 accesses the retailer order history link 212 responsive to triggers indicating an update to user purchases and/or orders with the online retailers.

In other examples, the user 208 may manually scrape order history data. For example, turning to FIG. 2B, an example fourth interface 216 and an example fifth interface 218 are illustrated. The example fourth interface 216 is the online retailer interface of the web browser and illustrates a third step of the operation of the collection controller 106. The example fourth interface 216 is the example second interface 204 of FIG. 2A but includes an example first scraper 220. The example fifth interface 218 is the online retailer interface of the mobile browser and illustrates the third step of the operation of the collection controller 106. The example fifth interface 218 is the example third interface 206 of FIG. 2A but includes an example second scraper 222.

In FIG. 2B, the example first scraper 220 of the example fourth interface 216 is implemented by a collection controller (e.g., such as the collection controller 106 of FIG. 1) and corresponds to the example scrape controller 112 of FIG. 1, such that when initiated, the example first scraper 220 scrapes and/or collects order history information from the online retailer of the web browser. In some examples, the first scraper 220 is manually initiated by the user 208 (e.g., the third step includes clicking on the extension 210). For example, the user 208 selects the extension 210 (not illustrated in the second interface 204 or the fourth interface 216) from an extension library and the fourth interface 216 presents the user 208 with the first scraper 220. In such an example, the user 208 may select a time period for the first scraper 220 to scrape order history from. For example, the first scraper 220 collects information from the retailer about purchases made between specific years, months, weeks, days, etc. In some examples, the first scraper 220 is not be user-initiated and, thus, is initiated upon a determination (e.g., a determination by a query controller, an activity monitor controller, and/or a timer such as the query controller 110, the activity monitor controller 116, and/or the timer 108 of FIG. 1) that products were newly purchased, an event occurred (e.g., a device was powered on, an application was opened, etc.), a time period expired, etc.

In FIG. 2B, the example second scraper 222 of the example fifth interface 218 is implemented by a collection controller (e.g., such as the collection controller 106 of FIG. 1) and corresponds to the example scrape controller 112 of FIG. 1 and the example first scraper 220, such that when initiated, the example second scraper 222 scrapes and/or collects order history information from the online retailer of the mobile browser. In some examples, the second scraper 222 is manually initiated by the user 208 (e.g., the third step includes clicking on the extension 210 from the extension library 214). In other examples, the second scraper 222 is not user-initiated and, thus, is initiated upon a determination (e.g., a determination by a query controller, an activity monitor controller, and/or a timer such as the query controller 110, the activity monitor controller 116, and/or the timer 108 of FIG. 1) that products were newly purchased, an event occurred (e.g., a device was powered on, an application was opened, etc.), a time period expired, etc.

FIG. 3 illustrates an example table 300 of data scraped from at least one of the example graphical user interfaces (e.g., 204/216, 206/218) of FIGS. 2A and 2B and/or from at least one of the datastores storing information displayed by the example graphical user interfaces. The example table 300 includes a number of columns including a first column 302, a second column 304, and a third column 306. The first column 302 is indicative of the item purchased from the online retailer, the second column 304 is indicative of the user (e.g., user 208 of FIG. 2A) who purchased the item and/or product of the first column, and the third column 306 is indicative of the date that the user of the second column 304 purchased the item of the first column 302.

In some examples, the first scraper 220 and/or the second scraper 222 scrapes the data illustrated in the table 300. For example, the first scraper 220 scrapes data from the web browser (e.g., the second interface 204 and/or fourth interface 216, the datastore storing information displayed at the second interface 204 and/or fourth interface 216, etc.) utilizing any type of data extraction algorithm, a ML model, a scraping algorithm, etc. In other examples the second scraper 222 scrapes the data from the mobile browser (e.g., the third interface 206 and/or fifth interface 218, the datastore storing information displayed at the third interface 206 and/or fifth interface 218, etc.) utilizing any type of data extraction algorithm, a ML model, a scraping algorithm, etc. In some examples, the first scraper 220 and/or the second scraper 222 stores the data of the table 300 in memory. In some examples, the memory is implemented by the memory 114 of FIG. 1.

Flowcharts representative of example hardware logic, machine readable instructions, hardware implemented state machines, and/or any combination thereof for implementing the collection controller 106 of FIG. 1 are shown in FIGS. 4-6. The machine readable instructions may be one or more executable programs or portion(s) of an executable program for execution by a computer processor and/or processor circuitry, such as the processor 712 shown in the example processor platform 700 discussed below in connection with FIG. 7. The program(s) may be embodied in software stored on a non-transitory computer readable storage medium such as a CD-ROM, a floppy disk, a hard drive, a DVD, a Blu-ray disk, or a memory associated with the processor 712, but the entire program and/or parts thereof could alternatively be executed by a device other than the processor 712 and/or embodied in firmware or dedicated hardware. Further, although the example program(s) is/are described with reference to the flowcharts illustrated in FIGS. 4-6, many other methods of implementing the example collection controller 106 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 4-6 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

A program 400 of FIG. 4 illustrates machine readable instructions for initializing the example collection controller 106 once installed on the device 102. For example, the program 400 implements an initialization phase of the example collection controller 106 of FIG. 1. The program 400 begins at block 402 when the example query controller 110 generates a request for permissions from the user. For example, the query controller 110 asks the user to give the collection controller 106 access to their online retailer accounts for viewing the corresponding retailer order history datastores 104.

The example query controller 110 obtains the permissions (block 404). In some examples, the query controller 110 waits until the permissions are obtained. For example, the query controller 110 waits for user input indicating “yes” or “no” to the generated request. In some examples, the query controller 110 waits for user credentials to be saved and/or stored in memory 114. For example, the query controller 110 obtains permissions and additionally obtains saved and/or stored user credentials to access user order history at any desired time.

The example query controller 110 generates a request for selections of relevant online retailers (block 406). For example, the query controller 110 provides the user, via an interface of the device 102, with a list of online retailers. The user is informed, via the request, to select all of the relevant online retailers for which the user holds an account with. In some examples, the query controller 110 determines a location of the device 102 in order to generate a list of relevant online retailers.

The example query controller 110 obtains the list of selections (block 408). For example, the query controller 110 obtains the list of online retailers for which a user of the device 102 holds accounts with, purchases products from, etc. In some examples, the list of online retailers is used to assist the collection controller 106 in generating requests (e.g., URL requests) for corresponding web pages (e.g., HTML pages including order history, retailer order history datastores 104, etc.).

The example collection controller 106 may initiate the counter variable T to zero (block 410). For example, the timer 108 may be triggered responsive to installation of the collection controller 106, responsive to the query controller 110 obtaining the list of selections, etc. The example timer 108 increments the value of the counter variable T (block 412). For example, the timer 108 begins counting responsive to being initialized and/or triggered. The example timer 108 determines if the value of the counter variable T meets a threshold (block 414). The threshold is indicative of a period of time that passes between collection of order history information. In some examples, the threshold is pre-defined by the central facility 120. In some examples, the threshold changes based on preferences set by the central facility 120.

If the value of the counter variable T does not meet the threshold (e.g., block 414 returns a NO), the timer 108 continues incrementing the counter variable T. If the value of the counter variable T meets the threshold (e.g., block 414 returns a YES), the example query controller 110 determines if the user is logged into (e.g., and/or visits) online retailer sites included in the selection of relevant online retailers (block 416). For example, the query controller 110 can determine, based on generating a web page request (e.g., a URL request), whether the user is logged into the account corresponding to the online retailer. In some examples, if the user is not logged in, the query controller 110 and/or the collection controller 106 obtains a response from the destination (e.g., the retailer site) indicating that access was denied. In other examples, if the user is logged in, the query controller 110 and/or the collection controller 106 obtains a response from the destination (e.g., the retailer site), the response including data (e.g., order history information, retailer information, etc.) from the requested web page.

If the example query controller 110 determines the user is not logged into the online retailer sites included in the selection of relevant online retailers (e.g., block 416 returns a value NO), the example query controller 110 generates a request for the user to provide login credentials for the online retailer sites (block 418). For example, the query controller 110 notifies the user to save the usernames and passwords for the accounts corresponding to the online retailer sites. In some examples, the query controller 110 generates a request indicative to store credentials for the online account associated with the user.

The example query controller 110 determines if an indication that a user has logged in has been received (block 420). For example, the query controller 110 queries the memory 114 for stored credentials, obtains a response from the user input, etc. If the query controller 110 has received an indication (e.g., block 420 returns a value YES), control returns to block 410 where the counter variable T resets. If the query controller 110 has not received an indication (e.g., block 420 returns a value NO), control returns to block 418.

If the example query controller 110 determines the user is logged into the online retailer sites included in the selection of relevant online retailers (e.g., block 416 returns a value YES), the example query controller 110 turns to program 500.

The program 500 of FIG. 5 illustrates machine readable instructions executed to collect order history information from retailer order history datastores 104. For example, the program 500 implements a collection phase of the collection controller 106 of FIG. 1. The program 500 begins at block 502, when the example query controller 110 selects an online retailer that the user is logged into. For example, the query controller 110 identifies an online retailer from the selection of relevant online retailers for scraping order history data from.

The example query controller 110 queries the selected retailer for the order history web page (block 504). For example, the query controller 110 generates and executes a URL request for the order history page of the selected and/or identified online retailer. As used herein, querying the retailer can be defined as retrieving and/or obtaining the order history pages of the selected online retailers. In some examples, querying the retailers includes retrieving and/or obtaining online listings of purchases made online versus in store.

The example scrape controller 112 scrapes the order history web page (block 506). For example, the scrape controller 112 obtains and/or otherwise collects images of the order history page that includes products bought, prices, etc.

The example scrape controller 112 obtains information from the scraped web page (block 508). In some examples, the scrape controller 112 utilizes data extraction algorithms to obtain information from the order history web page. In some examples, the scrape controller 112 utilizes a ML model to obtain relevant information from the scraped image of the order history web page. In some examples, the scrape controller 112 includes a structured data format that defines what information to grab from an image of the order history web page. For example, the structured data format may include locations of where the product name should be located, where the quantity of items bought should be located, where the price and promotional deals should be located, etc. In this manner, the example scrape controller 112 avoids scraping unnecessary information, such as advertisements, user information, etc.

The example scrape controller 112 identifies order characteristics in the obtained information (block 510). For example, the scrape controller 112 detects product names, price, quantity, promotional deals, etc., based on analyzing character strings of text for such information (e.g., matching text to strings of text stored in memory 114 corresponding to order history characteristics), based on utilizing the trained ML model, etc.

The example scrape controller 112 stores the information in memory 114 corresponding to the identified order characteristics (block 512). For example, the scrape controller 112 only stores the relevant information (e.g., product names, price, quantity, promotional deals, etc.) in memory 114.

The example scrape controller 112 and/or the example query controller 110 determines whether there is another online retailer (block 514). For example, based on the selection of online retailers, the scrape controller 112 and/or the query controller 110 determines if another online retailer order history page is to be processed. If the scrape controller 112 and/or the query controller 110 determines there is another online retailer order history page to be processed (e.g., block 514 returns a value YES), control returns to block 502). If the scrape controller 112 and/or the query controller 110 determines there is not another online retailer order history page to be processed (e.g., block 514 returns a value NO), the memory 114 is triggered to send information to central facility 120 (block 516).

A program 600 of FIG. 6 illustrates machine readable instructions for initializing the example collection controller 106 once installed on the device 102. The program 600 may be used in connection with the program 400 to initialize the collection controller 106. For example, the program 600 and the program 400 include similar methods and instructions to initialize the collection controller 106, such that both methods and instructions can be utilized simultaneously. Therefore, the program 600 may implement an example initialization phase of the example collection controller 106 of FIG. 1.

The program 600 begins at block 602 when the example query controller 110 generates a request for permissions from the user. For example, the query controller 110 asks the user to give the collection controller 106 access to their online retailer accounts for viewing the corresponding retailer order history datastores 104.

The example query controller 110 obtains the permissions (block 604). In some examples, the query controller 110 waits until the permissions are obtained. For example, the query controller 110 waits for user input indicating “yes” or “no” to the generated request. In some examples, the query controller 110 waits for user credentials to be saved and/or stored in memory 114. For example, the query controller 110 obtains permissions and additionally obtains saved and/or stored user credentials to access user order history at any desired time.

The example query controller 110 generates a request for selections of relevant online retailers (block 606). For example, the query controller 110 provides the user, via an interface of the device 102, with a list of online retailers. The user is informed, via the request, to select all of the relevant online retailers for which the user holds an account with. In some examples, the query controller 110 determines a location of the device 102 in order to generate a list of relevant online retailers.

The example query controller 110 obtains the list of selections (block 608). For example, the query controller 110 obtains the list of online retailers for which a user of the device 102 holds accounts with, purchases products from, etc. In some examples, the list of online retailers is used to assist the collection controller 106 in generating requests (e.g., URL requests) for corresponding web pages (e.g., HTML pages including order history, retailer order history datastores 104, etc.).

The example activity monitoring controller 116 monitors user activity (block 610). For example, the activity monitoring controller 116 waits for notifications corresponding to a user interaction with the device 102. In some examples, the activity monitoring controller 116 monitors event registers, event files, storage mediums having information corresponding to user input, etc.

The example activity monitoring controller 116 determines whether user activity is indicative of an action (block 614). For example, the activity monitoring controller 116 determines whether an event file has been updated with new event, whether a notification has been received corresponding to user input, etc. In some examples, when the activity monitoring controller 116 determines user activity is not indicative of an action (e.g., block 614 returns a value NO), the activity monitoring controller 116 continues to monitor user activity at block 610.

In other examples, when the activity monitoring controller 116 determines user activity is indicative of an action (e.g., block 614 returns a value YES), the example collection controller 106 determines if the user is logged into (e.g., and/or visits) online retailer sites included in the selection of relevant online retailers (block 616). For example, activity monitoring controller 116 notifies the query controller 110 to generate a web page request (e.g., a URL request) to selected online retailers to determine whether the user is logged into the corresponding accounts. In some examples, if the user is not logged in, the query controller 110 and/or the collection controller 106 obtains a response from the destination (e.g., the retailer site) indicating that access was denied. In other examples, if the user is logged in, the query controller 110 and/or the collection controller 106 obtains a response from the destination (e.g., the retailer site), the response including data (e.g., order history information, retailer information, etc.) from the requested web page.

If the example query controller 110 determines the user is not logged into the online retailer sites included in the selection of relevant online retailers (e.g., block 616 returns a value NO), the example query controller 110 generates a request for the user to provide login credentials for the online retailer sites (block 618). For example, the query controller 110 notifies the user to save the usernames and passwords for the accounts corresponding to the online retailer sites.

The example query controller 110 determines if an indication that a user has logged in has been received (block 620). For example, the query controller 110 queries the memory 114 for stored credentials, obtains a response from the user input, etc. If the query controller 110 has received an indication (e.g., block 620 returns a value YES), control returns to block 610 where the activity monitoring controller 116 monitors the activity of the user. If the query controller 110 has not received an indication (e.g., block 620 returns a value NO), control returns to block 618.

If the example query controller 110 determines the user is logged into the online retailer sites included in the selection of relevant online retailers (e.g., block 616 returns a value YES), the example query controller 110 turns to program 500.

FIG. 7 is a block diagram of an example processor platform 700 structured to execute the instructions of FIGS. 4-6 to implement the collection controller 106 of FIG. 1. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example timer 108, the example query controller 110, the example scrape controller 112, and the example activity monitoring controller 116.

The processor 712 of the illustrated example includes a local memory 713 (e.g., a cache). The local memory 713 implements the memory 114 in this example. The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives. In this example, the one or more mass storage devices 728 implement the example retailer order history datastore(s) 104 of FIG. 1.

The machine executable instructions 732 of FIGS. 4-6 may be stored in the mass storage device 728, in the volatile memory 714, in the non-volatile memory 716, and/or on a removable non-transitory computer readable storage medium such as a CD or DVD.

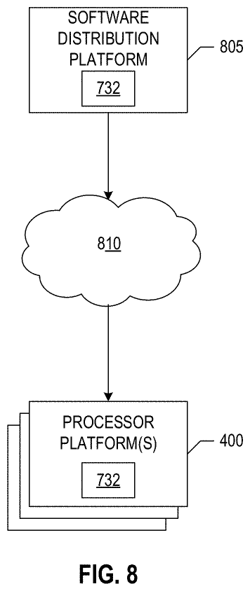

A block diagram illustrating an example software distribution platform 805 to distribute software such as the example computer readable instructions 732 of FIGS. 4-6 to third parties is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 732 of FIG. 7. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the computer readable instructions 732, which may correspond to the example computer readable instructions 400, 500, and/or 600 of FIGS. 4-6, as described above. The one or more servers of the example software distribution platform 805 are in communication with a network 810, which may correspond to any one or more of the Internet and/or any of the example networks 118 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 732 from the software distribution platform 805. For example, the software, which may correspond to the example computer readable instructions 400, 500, and 600 of FIGS. 4-6, may be downloaded to the example processor platform 700, which is to execute the computer readable instructions 732 (e.g., 400, 500, and 600 respectively) to implement the collection controller 106. In some example, one or more servers of the software distribution platform 805 periodically offer, transmit, and/or force updates to the software (e.g., the example computer readable instructions 732 of FIG. 7) to ensure improvements, patches, updates, etc. are distributed and applied to the software at the end user devices.

Example methods, apparatus, systems, and articles of manufacture to measure online purchasing history are disclosed herein. Further examples and combinations thereof include the following:

Example 1 includes an apparatus comprising a query controller to generate a first request to a first order history page of a first retailer based on obtaining authorization to access the first order history page, and generate a second request to a second order history page of a second retailer based on obtaining authorization to access the second order history page, the first and second retailers selected based on a list of retailers, and a scrape controller to scrape the first order history page and the second order history page, identify order characteristics based on information scraped from the first order history page and the second order history page, the order characteristics indicative of an online purchasing behavior corresponding to the first retailer and the second retailer, and store order characteristics in memory to subsequently provide to a central facility to determine online purchasing history.

Example 2 includes the apparatus of example 1, wherein the query controller is to generate a request for the access to the first order history page and the access to the second order history page.

Example 3 includes the apparatus of example 1, wherein the first order history page and the second order history page correspond to a user account, the query controller to generate a request to store credentials of the user account in memory, the request to provide authorization to access the first order history page and the second order history page.

Example 4 includes the apparatus of example 1, wherein the query controller is to generate the first request in response to a counter variable meeting a threshold, the counter variable indicative of a period of time between generating requests to scrape order history pages.

Example 5 includes the apparatus of example 1, further including an activity monitoring controller to determine whether an activity has occurred, the activity corresponding to an event at a device associated with the first order history page and the second order history page.

Example 6 includes the apparatus of example 5, wherein the query controller is to generate the first request and the second request in response to obtaining an indication that activity occurred.

Example 7 includes the apparatus of example 1, wherein the scrape controller is to identify the order characteristics utilizing a machine learning model that predicts which data in the information scraped corresponds to order characteristics.

Example 8 includes a non-transitory computer readable storage medium comprising instructions that, when executed, cause one or more processors to at least generate a first request to a first order history page of a first retailer based on obtaining authorization to access the first order history page, generate a second request to a second order history page of a second retailer based on obtaining authorization to access the second order history page, the first and second retailers selected based on a list of retailers, scrape the first order history page and the second order history page, identify order characteristics based on information scraped from the first order history page and the second order history page, the order characteristics indicative of an online purchasing behavior corresponding to the first retailer and the second retailer, and store order characteristics in memory to subsequently provide to a central facility to determine online purchasing history.

Example 9 includes the non-transitory computer readable storage medium of example 8, wherein the instructions, when executed, cause the one or more processors to generate a request for the access to the first order history page and the access to the second order history page.

Example 10 includes the non-transitory computer readable storage medium of example 8, wherein the first order history page and the second order history page correspond to a user account, the instructions to cause the one or more processors to generate a request to store credentials of the user account in memory, the request to provide authorization to access the first order history page and the second order history page.

Example 11 includes the non-transitory computer readable storage medium of example 8, wherein the instructions, when executed, cause the one or more processors to generate the first request in response to a counter variable meeting a threshold, the counter variable indicative of a period of time between generating requests to scrape order history pages.

Example 12 includes the non-transitory computer readable storage medium of example 8, wherein the instructions, when executed, cause the one or more processors to determine whether an activity has occurred, the activity corresponding to an event at a device associated with the first order history page and the second order history page.

Example 13 includes the non-transitory computer readable storage medium of example 12, wherein the instructions, when executed, cause the one or more processors to generate the first request and the second request in response to obtaining an indication that the activity occurred.

Example 14 includes the non-transitory computer readable storage medium of example 8, wherein the instructions, when executed, cause the one or more processors to identify the order characteristics utilizing a machine learning model that predicts which data in the information scraped corresponds to order characteristics.

Example 15 includes an apparatus comprising a memory to store instructions, and at least one processor to execute the instructions to generate a first request to a first order history page of a first retailer based on obtaining authorization to access the first order history page, generate a second request to a second order history page of a second retailer based on obtaining authorization to access the second order history page, the first and second retailers selected based on a list of retailers, scrape the first order history page and the second order history page, identify order characteristics based on information scraped from the first order history page and the second order history page, the order characteristics indicative of an online purchasing behavior corresponding to the first retailer and the second retailer, and store order characteristics in memory to subsequently provide to a central facility to determine online purchasing history.

Example 16 includes the apparatus of example 1, wherein the at least one processor is to generate a request for the access to the first order history page and the access to the second order history page.

Example 17 includes the apparatus of example 1, wherein the at least one processor is to generate the first request in response to a counter variable meeting a threshold, the counter variable indicative of a period of time between generating requests to scrape order history pages.

Example 18 includes the apparatus of example 1, wherein the at least one processor is to determine whether an activity has occurred, the activity corresponding to an event at a device associated with the first order history page and the second order history page.

Example 19 includes the apparatus of example 18, wherein the at least one processor is to generate the first request and the second request in response to obtaining an indication that activity occurred.

Example 20 includes the apparatus of example 15, wherein the at least one processor is to identify the order characteristics utilizing a machine learning model that predicts which data in the information scraped corresponds to order characteristics.

From the foregoing, it will be appreciated that example methods, apparatus and articles of manufacture have been disclosed that measure online purchasing history by automatically checking and querying retailer order history pages and/or retailer order history datastores of multiple online retailers. Examples disclosed herein include a simplistic and non-invasive approach to collecting retailer order history information of users by screen scraping an order history web page, collecting data if a data structured format is available in the order history web page, collecting data via an application programming interface (API) if the API for the online retailer is available, and/or utilizing machine learning to obtain relevant information from a scraped web page.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus comprising:
a query controller to:
generate a first request to a first order history page of a first retailer based on obtaining authorization to access the first order history page; and
generate a second request to a second order history page of a second retailer based on obtaining authorization to access the second order history page, the first and second retailers selected based on a list of retailers; and
a scrape controller to:
scrape the first order history page and the second order history page;
identify order characteristics based on information scraped from the first order history page and the second order history page, the order characteristics indicative of an online purchasing behavior corresponding to the first retailer and the second retailer; and
store order characteristics in memory to subsequently provide to a central facility to determine online purchasing history.

2. The apparatus of claim 1, wherein the query controller is to generate a request for the access to the first order history page and the access to the second order history page.

3. The apparatus of claim 1, wherein the first order history page and the second order history page correspond to a user account, the query controller to generate a request to store credentials of the user account in memory, the request to provide authorization to access the first order history page and the second order history page.

4. The apparatus of claim 1, wherein the query controller is to generate the first request in response to a counter variable meeting a threshold, the counter variable indicative of a period of time between generating requests to scrape order history pages.

5. The apparatus of claim 1, further including an activity monitoring controller to determine whether an activity has occurred, the activity corresponding to an event at a device associated with the first order history page and the second order history page.

6. The apparatus of claim 5, wherein the query controller is to generate the first request and the second request in response to obtaining an indication that activity occurred.

7. The apparatus of claim 1, wherein the scrape controller is to identify the order characteristics utilizing a machine learning model that predicts which data in the information scraped corresponds to order characteristics.

8. A non-transitory computer readable storage medium comprising instructions that, when executed, cause one or more processors to at least:
generate a first request to a first order history page of a first retailer based on obtaining authorization to access the first order history page;
generate a second request to a second order history page of a second retailer based on obtaining authorization to access the second order history page, the first and second retailers selected based on a list of retailers;
scrape the first order history page and the second order history page;
identify order characteristics based on information scraped from the first order history page and the second order history page, the order characteristics indicative of an online purchasing behavior corresponding to the first retailer and the second retailer; and
store order characteristics in memory to subsequently provide to a central facility to determine online purchasing history.

9. The non-transitory computer readable storage medium of claim 8, wherein the instructions, when executed, cause the one or more processors to generate a request for the access to the first order history page and the access to the second order history page.

10. The non-transitory computer readable storage medium of claim 8, wherein the first order history page and the second order history page correspond to a user account, the instructions to cause the one or more processors to generate a request to store credentials of the user account in memory, the request to provide authorization to access the first order history page and the second order history page.

11. The non-transitory computer readable storage medium of claim 8, wherein the instructions, when executed, cause the one or more processors to generate the first request in response to a counter variable meeting a threshold, the counter variable indicative of a period of time between generating requests to scrape order history pages.

12. The non-transitory computer readable storage medium of claim 8, wherein the instructions, when executed, cause the one or more processors to determine whether an activity has occurred, the activity corresponding to an event at a device associated with the first order history page and the second order history page.

13. The non-transitory computer readable storage medium of claim 12, wherein the instructions, when executed, cause the one or more processors to generate the first request and the second request in response to obtaining an indication that the activity occurred.

14. The non-transitory computer readable storage medium of claim 8, wherein the instructions, when executed, cause the one or more processors to identify the order characteristics utilizing a machine learning model that predicts which data in the information scraped corresponds to order characteristics.

15. An apparatus comprising:
a memory to store instructions; and
at least one processor to execute the instructions to:
generate a first request to a first order history page of a first retailer based on obtaining authorization to access the first order history page;
generate a second request to a second order history page of a second retailer based on obtaining authorization to access the second order history page, the first and second retailers selected based on a list of retailers;
scrape the first order history page and the second order history page;
identify order characteristics based on information scraped from the first order history page and the second order history page, the order characteristics indicative of an online purchasing behavior corresponding to the first retailer and the second retailer; and
store order characteristics in memory to subsequently provide to a central facility to determine online purchasing history.

16. The apparatus of claim 1, wherein the at least one processor is to generate a request for the access to the first order history page and the access to the second order history page.

17. The apparatus of claim 1, wherein the at least one processor is to generate the first request in response to a counter variable meeting a threshold, the counter variable indicative of a period of time between generating requests to scrape order history pages.

18. The apparatus of claim 1, wherein the at least one processor is to determine whether an activity has occurred, the activity corresponding to an event at a device associated with the first order history page and the second order history page.

19. The apparatus of claim 18, wherein the at least one processor is to generate the first request and the second request in response to obtaining an indication that activity occurred.

20. The apparatus of claim 15, wherein the at least one processor is to identify the order characteristics utilizing a machine learning model that predicts which data in the information scraped corresponds to order characteristics.
